(19) United States
(12) Patent Application Publication
(10) Pub. No.: US 2020/0167067 A1
(43) Pub. Date: May 28, 2020

(54) DISPLAY DEVICE, AND DISPLAY METHOD THEREOF

(71) Applicant: KYOCERA Document Solutions Inc., Osaka (JP)

(72) Inventor: Ken NISHIO, Osaka (JP)

(73) Assignee: KYOCERA Document Solutions Inc., Osaka (JP)

(21) Appl. No.: 16/612,082

(22) PCT Filed: Apr. 23, 2018
(86) PCT No.: PCT/JP2018/016459

§ 371 Date: Nov. 8, 2019

(30) Foreign Application Priority Data
Jun. 28, 2017 (JP) 2017-126636

(51) Int. Cl. G06F 3/0485; G06F 3/0481; G06F 3/0488; G06F 3/0354; G06F 3/0484

(52) U.S. Cl. CPC G06F 3/04855; G06F 3/04812; G06F 3/04845; G06F 3/04886; G06F 3/03543; G06F 3/04817

(57) ABSTRACT

When an image to be displayed is a scrollable image that can be scrolled while being displayed on a display device (21) of an information processing apparatus (1), a display controller (12) stores a position in the scrollable image, of an image being displayed in a display region of the display device (21) at the time that the operation receiver has received a scroll start instruction, in a HDD (24) as a scroll start position. The display controller (12) also returns an image in the scrollable image currently displayed in the display region at the time that a return instruction has been received, to an image that was displayed in the display region when the start instruction, corresponding to the scroll start position stored in the HDD (24), was received.

### TECHNICAL FIELD

The present invention relates to a display device and a display method to be performed by the display device, and in particular to a technique to return, after once scrolling an image on a screen, the scrolled image to the original image displayed before being scrolled.

### BACKGROUND ART

Existing display devices are normally configured to scroll display contents displayed on the display device, according to an instruction of a user. The display devices are also configured to display a scroll bar including a knob that indicates, while the scroll display is performed, which portion of the overall image displayed on the display device is currently displayed in the display region of the display device.

Further, various inventions have been proposed, to improve the user-friendliness of the display device by utilizing the scroll bar. For example, Patent Literature (PTL) 1 cited below proposes a technique to return the scrolled display to the status before the scrolling was performed. This technique includes a bookmark insertion process including storing a screen scroll position corresponding to the current screen display status, when the user performs a predetermined operation on the knob (scroll handle) of the scroll bar, and adding a bookmark symbol on the position on the scroll bar corresponding to the current position of the knob, and a bookmark returning process including returning, when the user performs a predetermined operation on the bookmark symbol, the display status at that time to the position corresponding to the screen scroll position stored earlier.

### CITATION LIST

### Patent Literature

[PTL 1] Japanese Unexamined Patent Application Publication No. 9-325879

### SUMMARY OF INVENTION

With the technique according to PTL 1, however, the user has to perform the predetermined operation on the knob of the scroll bar each time, to store the screen scroll position corresponding to the current screen display status (i.e., image being displayed in the display region of the display device). In other words, the user has to perform the predetermined operation on the knob each time, to obtain the image displayed before the scrolling was performed. Accordingly, with the mentioned technique, it is difficult to alleviate the operating burden on the user. With the foregoing technique, further, for example when the user forgets to perform the predetermined operation on the knob to newly store the screen scroll position of a desired displayed image, after the bookmark symbol was added (after the screen scroll position was stored), and then performs the predetermined operation on the bookmark symbol currently displayed, the image newly required by the user is not displayed, but a different image, the screen scroll position of which was stored earlier, is displayed. With the foregoing technique, therefore, the image required by the user may fail to be correctly displayed.

The present invention has been accomplished in view of the foregoing situation, and provides a technique to enable, when the scroll display is performed, the image displayed before the scrolling was performed to be correctly displayed as desired by the user, with reduced operating burden on the user.

### Solution to Problem

In an aspect, the present invention provides a display device including an operation receiver that receives an instruction from a user, a storage device, a display device, and a display controller that controls an operation of the display device, and scrolls, when the operation receiver receives from the user a start instruction to scroll a display content displayed on the display device, the display content displayed on the display device according to the start instruction. When the image to be displayed is a scrollable image that can be scrolled while being displayed on the display device, the display controller stores a position in the scrollable image, of the image being displayed in a display region of the display device at the time that the operation receiver has received the start instruction, in the storage device as a scroll start position, and returns, when the operation receiver receives from the user a predetermined return instruction related to returning of the displayed image, the image in the scrollable image currently displayed in the display region at the time that the return instruction has been received, to the image that was displayed in the display region when the start instruction, corresponding to the scroll start position stored in the storage device, was received.

In another aspect, the present invention provides a display method to be performed by a display device including an operation receiver that receives an instruction from a user, a storage device, a display device, and a display controller that controls an operation of the display device, and scrolls, when the operation receiver receives from the user a start instruction to scroll a display content displayed on the display device, the display content displayed on the display device according to the start instruction. The method includes causing the display controller to store, when the image to be displayed is a scrollable image that can be scrolled while being displayed on the display device, a position in the scrollable image, of the image being displayed in a display region of the display device at the time that the operation receiver has received the start instruction, in the storage device as a scroll start position, and to return, when the operation receiver receives from the user a predetermined return instruction related to returning of the displayed image, the image in the scrollable image currently displayed in the display region at the time that the return instruction has been received, to the image that was displayed in the display region when the start instruction, corresponding to the scroll start position stored in the storage device, was received.

### Advantageous Effects of Invention

The foregoing arrangement enables, when the display is scrolled, the image displayed before the scrolling was performed, to be correctly displayed as desired by the user, with reduced operating burden on the user.

### BRIEF DESCRIPTION OF DRAWINGS

FIG. 1 is a functional block diagram showing an essential configuration of an information processing apparatus according to an embodiment, exemplifying the display device in the present invention.

FIG. 2 is a schematic drawing showing an example of a screen displayed on the display device.

FIG. 3 is a schematic drawing showing an example of document data generated by a document data generator.

FIG. 4 is a flowchart showing an operation performed by the information processing apparatus.

FIG. 5A and FIG. 5B are schematic drawings each showing an example of the screen displayed on the display device.

### DESCRIPTION OF EMBODIMENTS

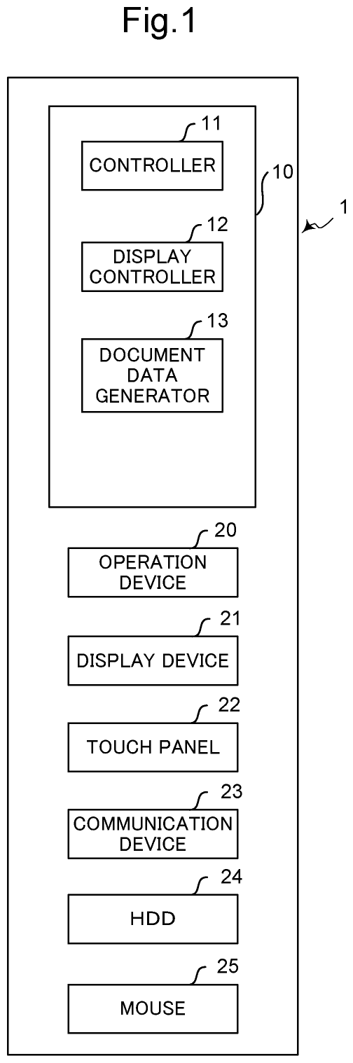

Hereafter, a display device and a display method to be performed by the display device according to an embodiment of the present invention will be described, with reference to the drawings. FIG. 1 is a functional block diagram showing an essential configuration of an information processing apparatus according to the embodiment, exemplifying the display device in the present invention.

In FIG. 1, the display device according to the embodiment of the present invention is exemplified by the information processing apparatus 1. The information processing apparatus 1 may be, for example, a personal computer. The information processing apparatus 1 includes a control device 10, an operation device 20, a display device 21, a touch panel 22, a communication device 23, and a hard disk drive (HDD) 24. The mentioned components are configured to transmit and receive data and signals to and from each other, via a CPU bus. The control device 10 includes a processor, a random-access memory (RAM), a read-only memory (ROM), and so forth. The processor is, for example, a central processing unit (CPU), a MPU, or an ASIC. The control device 10 acts as a controller 11, a display controller 12, and a document data generator 13, when the processor executes an operation control program stored, for example, in the HDD 24. However, the controller 11, the display controller 12, and the document data generator 13 of the control device 10 may each be constituted of a hardware circuit, instead of being realized by the operation according to the operation control program. This also applies to other embodiments, unless otherwise specifically noted.

The controller 11 serves to control the overall operation of the information processing apparatus 1.

The display controller 12 is configured to control the displaying operation of the display device 21.

The document data generator 13 generates document data, upon receipt of an instruction from the user made through the operation device 20 or the touch panel 22, according to an application stored in advance in the HDD 24. The document data generator 13 generates document data including, for example, a file created according to the application that runs in the information processing apparatus 1, such as a word processor, spreadsheet software, or drawing software, and image data of the jpeg or PDF format.

The document data generator 13 also reads out, according to the instruction from the user made through the operation device 20 or the touch panel 22, the document data from the HDD 24, or from outside of the information processing apparatus 1, for example a server connected to the communication device 23 via a non-illustrated network. The document data generator 13 performs an addition, deletion, or modification with respect to the document data read out as above, thereby generating renewed document data, according to the instruction from the user made through the operation device 20 or the touch panel 22.

The display controller 12 scrolls, when an operation receiver to be subsequently described receives from the user a start instruction to scroll a display content displayed on the display device 21 (e.g., the document data), the display content being displayed on the display device 21, in response to the start instruction.

When the image to be displayed is a scrollable image that can be scrolled while being displayed on the display device 21, the display controller 12 stores a position in the scrollable image, of the image being displayed in a display region of the display device 21 at the time that the operation receiver has received the start instruction, as a scroll start position in the storage device such as the HDD 24 or a non-illustrated memory. Here, the scrollable image refers to an image that the display controller 12 causes the display device 21 to display, as the image to be scrolled. In other words, the scrollable image refers to an image, the entirety of which is unable to be displayed at a time in the display region of the display device 21, unless the image is scrolled.

In addition, the display controller 12 displays a scroll bar including a knob that indicates the position in the scrollable image of the image being displayed in the display region, in a predetermined location in the display device 21. Further, when the operation receiver receives a drag operation of the user performed on the knob, the display controller 12 scrolls the scrollable image, in response to the drag operation.

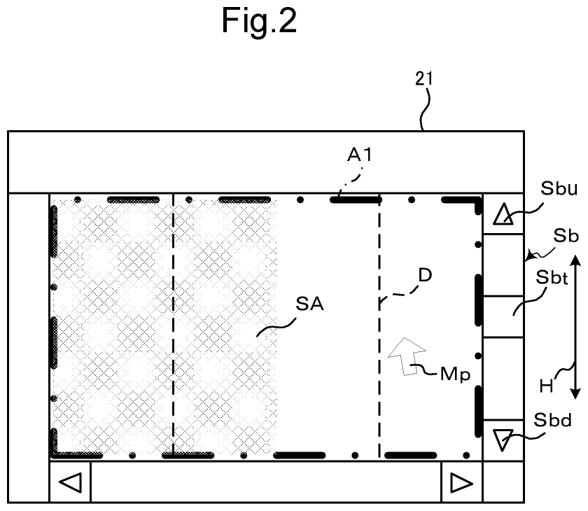

For example, the display controller 12 defines a display region A1 in the screen of the display device 21 as indicated by dash-dot lines in FIG. 2, and displays the image (scrollable image) such as the document data D, in the display region A1. Also as shown in FIG. 2, the display controller 12 displays a scroll bar Sb including a knob Sbt, an arrow Sbu for scrolling down the scrollable image displayed in the display region A1, and an arrow Sbd for scrolling up the scrollable image displayed in the display region A1, in a location provided at the right end portion of the screen of the display device 21. The display controller 12 also displays on the screen a mouse pointer Mp, indicating the position on the screen pointed by a mouse 25 included in the operation device 20, when the user operates the mouse 25, in a form of a predetermined icon, such as an arrow. Further, when the operation receiver receives the drag operation performed by the user, with the mouse 25 to move the knob Sbt in the scroll direction indicated by a two-way arrow H in FIG. 2, the display controller 12 scrolls the scrollable image displayed in the display region A1, according to the movement of the knob Sbt (i.e., drag operation).

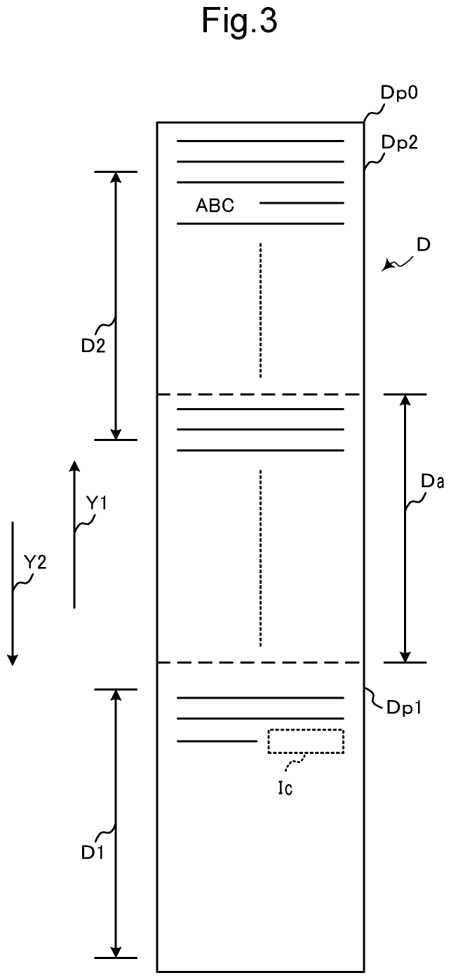

For example, when the operation receiver receives the user's operation of moving the knob Sbt in the scroll-up direction, in the state where a portion Da of the document data D is displayed in the display region A1 (see FIG. 2) as shown in FIG. 3, the display controller 12 scrolls the document data D downward in FIG. 3, to thereby display, for example, a portion D1 of the document data D, in the display region A1. Likewise, when the operation receiver receives the user's operation of moving the knob Sbt in the scroll-down direction, in the state where the portion Da of the document data D is displayed in the display region A1, the display controller 12 scrolls the document data D upward in FIG. 3, to thereby display, for example, a portion D2 of the document data D, in the display region A1.

Thereafter, when the operation receiver receives from the user a predetermined return instruction related to returning of the displayed image, while the display device 21 is performing the scroll display, the display controller 12 returns the image in the scrollable image currently displayed in the display region A1 at the time that the return instruction has been received, to the image that was displayed in the display region A1 when the start instruction, corresponding to the scroll start position stored in the storage device, was received.

The operation receiver decides that the return instruction has been received from the user, for example upon detecting, after receiving the drag operation performed by the user on the knob Sbt, that the mouse pointer Mp is located in a predetermined effective area in the display region A1, as result of the user's operation of the mouse 25, and also detecting that the user has released the click button of the mouse 25, from his/her finger. Here, the display controller 12 may define, for example, a half portion of the display region A1 on the left, distant from the scroll bar Sb, as the effective area SA, as shown in FIG. 2. Further, the display controller 12 displays the icon representing the mouse pointer Mp in different forms, between the case where the operation receiver has detected that the mouse pointer Mp is located outside the effective area SA in the display device 21, and the case where the operation receiver has detected that the mouse pointer Mp is located inside the effective area SA (further detail will subsequently follow).

The operation device 20 includes a keyboard having hard keys, the mouse 25, and a pointing device, and receives, for example, an instruction from the user designating the document data to be displayed as a scroll image.

The display device 21 is constituted of, for example, a liquid crystal display or an organic EL display.

The touch panel 22 is provided on the front face of the display device 21. The touch panel 22 is based on a resistive film or electrostatic capacitance, and configured to detect a contact (touch) made by the user, along with the touched position. Upon detecting the touch of the user, the touch panel 22 outputs a detection signal indicating the coordinate position of the touched position, to the controller 11. Here, the operation device 20 and the touch panel 22, the mouse 25 inclusive, exemplify the operation receiver in the present invention.

The communication device 23 includes a communication module such as a LAN board, and transmits and receives various types of data, to and from a server or an image forming apparatus under the control of the controller 11, through a non-illustrated network to which the communication device 23 is connected.

The HDD 24 is a large-capacity storage device for storing the application, and the document data generated with the application. Here, the HDD 24 exemplifies the storage device in the present invention.

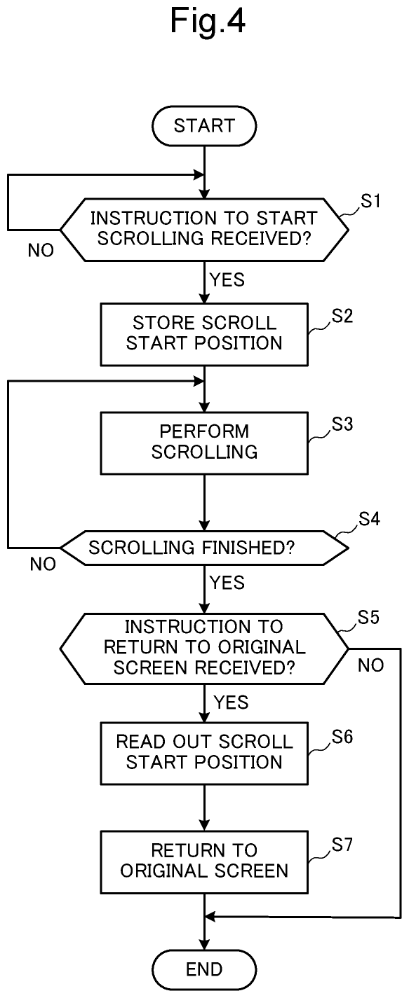

Referring now to FIG. 4, an operation of the information processing apparatus 1 according to this embodiment will be specifically described. FIG. 4 is a flowchart showing the operation performed by the information processing apparatus. The following description primarily refers to the operation of the display controller 12, performed to scroll the document data D displayed as the scrollable image, when the screen shown in FIG. 2 is displayed on the display device 21.

The display controller 12 decides whether the operation receiver has received a request from the user to start the scroll display of the document data D (S1). For example, the display controller 12 may decide that the request to start the scroll display of the document data D has been received, by detecting whether the knob Sbt (see FIG. 2) has been moved by the user in the scroll-up direction or scroll-down direction. In the case where the touch panel 22 has not detected that the knob Sbt has been moved (NO at S1), the display controller 12 keeps the information processing apparatus 1 in a standby state, without proceeding to S2.

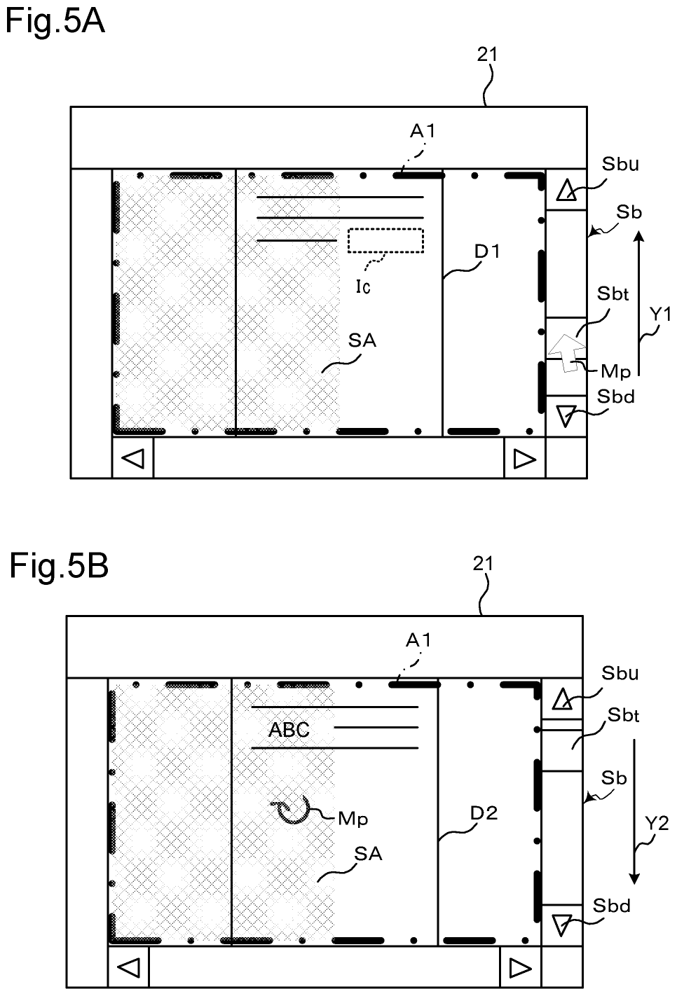

In contrast, in the case where the touch panel 22 has detected that the knob Sbt has been moved by the user (YES at S1), the display controller 12 decides that the start instruction from the user to scroll the display of the document data D has been received, and stores the position in the scrollable image, of the image being displayed in the display region A1 of the display device 21 at the time that the start instruction has been received, in the HDD 24 as the scroll start position (S2). For example, in the case where the portion D1 of the document data D is displayed in the display region A1 of the display device 21 as shown in FIG. 5A, the display controller 12 stores a predetermined position in the portion D1, for example an upper end Dp1 thereof (see FIG. 3) as the scroll start position in the HDD 24, when the user starts to move the knob Sbt in the scroll-down direction, thus making the start instruction, for example to fill in data in a blank in the portion D1. Here, the position of the upper end Dp1 represents the position in the document data D, for example with respect to an uppermost end Dp0 (see FIG. 3) of the document data D, and the position information of the upper end Dp1 (i.e., information of the distance from the uppermost end Dp0) is stored in the HDD 24, as the scroll start position. Likewise, the position of another upper end Dp2 (see FIG. 3) to be subsequently described represents the position in the document data D, with respect to the uppermost end Dp0.

The display controller 12 then performs scroll display of the document data D, in response to the user's drag operation made on the knob Sbt (S3). For example, the display controller 12 scrolls down the screen from the portion D1 of the document data D, as indicated by an arrow Y1 in FIG. 3, to obtain the image to be displayed in the display region A1 of the display device 21.

Thereafter, the display controller 12 decides whether the operation receiver has received an instruction from the user to finish the scroll display of the document data D (S4). For example, the display controller 12 detects whether the drag operation performed on the knob Sbt in the scroll-down direction has been cancelled, in other words whether the click button has been released, to thereby decide whether the operation receiver has received the instruction to finish the scroll display of the document data D. Unless the touch panel 22 has detected that the drag operation performed on the knob Sbt has been cancelled (NO at S4), the display controller 12 returns to S3 and repeats the same operation.

In contrast, in the case where the touch panel 22 has detected that the drag operation performed on the knob Sbt has been cancelled (YES at S4), the display controller 12 decides whether the operation receiver has received the return instruction from the user (S5). For example, display controller 12 detects whether the operation receiver has recognized that the user has released the click button of the mouse 25, while the mouse pointer Mp is located in the effective area SA (see FIG. 2) by the user's operation performed on the mouse 25, to thereby decide whether the operation receiver has received the return instruction. Upon detecting that the mouse pointer Mp is not located in the effective area SA (NO at S5), the display controller 12 decides that return instruction for the displayed image has not been received, and finishes the operation.

In contrast, upon detecting that the mouse pointer Mp is located in the effective area SA by the user's operation performed on the mouse 25, and that it has been recognized that the user has released the click button of the mouse 25 (YES at S5), the display controller 12 decides that the return instruction has been received from the user. Then the display controller 12 reads out, from the HDD 24, the scroll start position stored therein (S6).

For example, upon detecting through the touch panel 22 that the mouse pointer Mp is located in the effective area SA as shown in FIG. 5B, by the user's operation performed on the mouse 25, the display controller 12 changes the display of the icon representing the mouse pointer Mp. More specifically, while it is detected through the touch panel 22 that the mouse pointer Mp is not located in the effective area SA, the display controller 12 display the icon representing the mouse pointer Mp, for example in a form of a blank arrow as shown in FIG. 5A. In contrast, when it is detected through the touch panel 22 that the mouse pointer Mp is located in the effective area SA, the display controller 12 display the icon representing the mouse pointer Mp, for example in a form of an inverted arrow as shown in FIG. 5B.

Upon detecting that the user has released the click button of the mouse 25, while it is detected through the touch panel 22 that the mouse pointer Mp is located in the effective area SA as shown in FIG. 5B, the display controller 12 decides that the return instruction has been received from the user, and reads out the scroll start position from the HDD 24. The display controller 12 then scrolls up the screen from the portion D2 of the document data D currently displayed in the display region A1, as indicated by an arrow Y2 in FIG. 5B, so as to return to the image that was displayed before the scrolling was performed (i.e., the image of the portion D1 shown in FIG. 5A), according to the scroll start position read out as above (S7).

More specifically, the display controller 12 returns the screen display from the current position of the document data D (scrollable image) displayed at the time that the touch panel 22 has received the return instruction, in other words from the upper end DP2 (see FIG. 3) of the portion D2 of the document data D displayed in the display region A1, to the scroll start position of the document data D determined when the touch panel 22 received the scroll start instruction, in other words the upper end Dp1 (see FIG. 3), to thereby display the portion D1 of the document data D in the display region A1, which was displayed in the display region A1 when the scroll start instruction was received. Thus, the screen shown in FIG. 5A is transferred to the screen shown in FIG. 5B, and then the screen shown in FIG. 5B is transferred to the screen shown in FIG. 5A. Therefore, for example when the user finds out, in the document data D, a blank Ic in the portion D1 where a phrase “ABC” is to be inputted, the user can easily acquire the phrase “ABC” from the portion D2, and input the acquired phrase “ABC” in the blank Ic.

According to this embodiment, as described above, when the image to be displayed is a scrollable image that can be scrolled while being displayed on the display device 21, the display controller 12 stores the position in the scrollable image, of the image being displayed in the display region A1 of the display device 21 at the time that the operation receiver has received the scroll start instruction, in the HDD 24 as the scroll start position. The display controller 12 also returns, when the operation receiver receives from the user the predetermined return instruction related to returning of the displayed image, the image in the scrollable image currently displayed in the display region A1 at the time that the return instruction has been received, to the image that was displayed in the display region A1 when the start instruction, corresponding to the scroll start position stored in the HDD 24, was received. Unlike the conventional technique, the mentioned arrangement according to this embodiment enables, when the display is scrolled, the image displayed before the scrolling was performed, to be correctly displayed as desired by the user, with reduced operating burden on the user.

According to the foregoing embodiment, the display controller 12 also displays, in the predetermined location in the display device 21, the scroll bar Sb including the knob Sbt indicating the position in the scrollable image of the image displayed in the display region A1. In addition, when the operation receiver receives the user's drag operation on the knob Sbt, the display controller 12 scrolls the scrollable image in response to the drag operation. Accordingly, the arrangement according to the embodiment facilitates the user to scroll the image displayed in the display region A1.

In the foregoing embodiment, further, the operation device 20 (operation receiver) includes the mouse 25 to be operated by the user. The operation device 20 decides that the return instruction has been received from the user, upon detecting that the mouse pointer Mp is located in the predetermined effective area SA by the user's operation performed on the mouse 25, and that the user has released the click button of the mouse 25. The mentioned arrangement according to the embodiment enables the return instruction from the user to be accurately and securely received.

Further, the display controller 12 displays the icon representing the mouse pointer Mp on the display device 21 when scrolling the scrollable image, and in different forms between the case where the operation receiver has detected that the mouse pointer Mp is located outside the effective area SA in the display device 21, and the case where the operation receiver has detected that the mouse pointer Mp is located inside the effective area SA. Therefore, the user can decide whether the mouse pointer Mp is located inside the effective area SA, simply by visually recognizing the icon of the mouse pointer Mp, to properly input the return instruction.

The configurations and arrangements according to the foregoing embodiment, described with reference to FIG. 1 to FIG. 5, are merely exemplary, and in no way intended to limit the present invention to those configurations and arrangements.

For example, although the series of operations of the user have been described as the operation performed with the mouse 25, the user may directly operate the touch panel with the finger, to perform the drag operation on the knob, so that whether the return instruction has been received may be decided depending on the position where the finger is removed from the touch panel.

In the foregoing embodiment, the display region A1 includes an area close to the scroll bar Sb and an area distant from the scroll bar Sb, out of which the display controller 12 defines the area in the display region A1 distant from the scroll bar Sb (i.e., half portion on the left) as the effective area SA, as shown in FIG. 2. However, different configurations may be adopted. For example, the portions in the display region A1 other than the scroll bar Sb and the document data D may be defined as the effective area SA. In particular, in the case where the portion in the display region A1 between the document data D and the scroll bar Sb in FIG. 2 is defined as the effective area SA, the mouse pointer Mp can be moved to the effective area SA by a shorter stroke of the mouse, after the operation receiver has received the user's drag operation performed on the knob Sbt, and therefore the operability can be improved.

1. A display device comprising:
an operation receiver that receives an instruction from a user;
a storage device;
a display device; and
a display controller that controls an operation of the display device, and scrolls, when the operation receiver receives from the user a start instruction to scroll a display content displayed on the display device, the display content displayed on the display device according to the start instruction,
wherein, when an image to be displayed is a scrollable image that can be scrolled while being displayed on the display device, the display controller stores a position in the scrollable image, of the image being displayed in a display region of the display device at the time that the operation receiver has received the start instruction, in the storage device as a scroll start position, and
the display controller returns, when the operation receiver receives from the user a predetermined return instruction related to returning of the displayed image, the image in the scrollable image currently displayed in the display region at the time that the return instruction has been received, to the image that was displayed in the display region when the start instruction, corresponding to the scroll start position stored in the storage device, was received.

2. The display device according to claim 1,
wherein the display controller displays, in a predetermined location in the display device, a scroll bar including a knob indicating a position in the scrollable image of the image displayed in the display region, and
when the operation receiver receives a drag operation performed by the user on the knob, the display controller scrolls the scrollable image in response to the drag operation.

3. The display device according to claim 2,
wherein the operation receiver includes a mouse to be operated by the user, and
the operation receiver decides that the return instruction has been received from the user, upon detecting that a mouse pointer is located in a predetermined effective area by the operation performed by the user on the mouse, and that the user has released a click button of the mouse.

4. The display device according to claim 3,
wherein the display controller displays an icon representing the mouse pointer on the display device when scrolling the scrollable image, and displays the icon in different forms, between a case where the operation receiver has detected that the mouse pointer is located outside the effective area in the display device, and a case where the operation receiver has detected that the mouse pointer is located inside the effective area.

5. The display device according to claim 3,
wherein the display region includes an area close to the scroll bar and an area distant from the scroll bar, and the display controller defines the area in the display region distant from the scroll bar as the effective area.

6. The display device according to claim 1,
wherein the operation receiver includes a touch panel, and
decides that the return instruction has been received from the user, upon detecting that a position on the touch panel touched by the user is located in a predetermined effective area in the display region, and that the user has stopped touching the touch panel.

7. The display device according to claim 6,
wherein the display region includes an area close to the scroll bar and an area distant from the scroll bar, and the display controller defines the area in the display region distant from the scroll bar as the effective area.

8. The display device according to claim 2,
wherein the operation receiver includes a touch panel, and
decides that the return instruction has been received from the user, upon detecting that a position on the touch panel touched by the user is located in a predetermined effective area in the display region, and that the user has stopped touching the touch panel.

9. The display device according to claim 8,
wherein the display region includes an area close to the scroll bar and an area distant from the scroll bar, and the display controller defines the area in the display region distant from the scroll bar as the effective area.

10. A display method to be performed by a display device including an operation receiver that receives an instruction from a user, a storage device, a display device, and a display controller that controls an operation of the display device, and scrolls, when the operation receiver receives from the user a start instruction to scroll a display content displayed on the display device, the display content displayed on the display device according to the start instruction, the method comprising causing the display controller to:
store, when an image to be displayed is a scrollable image that can be scrolled while being displayed on the display device, a position in the scrollable image, of the image being displayed in a display region of the display device at the time that the operation receiver has received the start instruction, in the storage device as a scroll start position; and
return, when the operation receiver receives from the user a predetermined return instruction related to returning of the displayed image, the image in the scrollable image currently displayed in the display region at the time that the return instruction has been received, to the image that was displayed in the display region when the start instruction, corresponding to the scroll start position stored in the storage device, was received.
